(19) United States
(12) Patent Application Publication
(10) Pub. No.: US 2008/0111658 A1
(43) Pub. Date: May 15, 2008

(54) Safety power disconnection terminal apparatus with light indication

(76) Inventor: Ming-Lin Yang, Hsinchu City (TW)

Correspondence Address: Dykema Gossett, PLLC, Suite 300 West, 1300 I Street, N.W., Washington, DC, 20005-3306, US

(21) Appl. No.: 11/595,969

(22) Filed: Nov. 13, 2006

(51) Int. Cl. H01H 85/32

(52) U.S. Cl. 337/242

(57) ABSTRACT

The present invention discloses a safety power disconnection terminal apparatus with light indication that includes: a housing, having two inspecting openings and a light transmitting portion at the top of the housing and an opening at the bottom of the housing; a terminal pin installed in the housing through the openings and composed of two parallel conducting plates and a fuse connected between the two conducting plates and a terminal portion disposed at an upper end of the two conducting plates and extended into the two inspecting openings, and a L-shape stand disposed proximate to an internal side of an upper end of the two conducting plates and having a free end extended upward; a light emitting device, installed in the light transmitting portion, and having two electrodes in contact with the two L-shape stands respectively to achieve the effects of expediting the installation and lowering the manufacturing cost.

### FIELD OF THE INVENTION

The present invention relates to a safety power disconnection terminal apparatus with light indication, and more particularly to a safety power disconnection terminal apparatus that can achieve the effects of expediting the installation and lowering the manufacturing cost.

### BACKGROUND OF THE INVENTION

Referring to FIG. 1 for an exploded view of a traditional structure of a fuse terminal with light indication, the structure includes:
a housing 1, having an opening 11 that penetrates the top and the bottom of the housing 1;
a terminal pin 2, comprised of two parallel metal conducting plates 21, a fuse 22 connected between the two metal conducting plates 21, a terminal portion 24 disposed at an upper end 23 of the metal conducting plate 21, and a L-shape stand 25 having an outwardly extended free end and disposed at an internal side of an upper end 23 of the metal conducting plate 21;
an upper, casing 3, being a transparent object, for covering the corresponding opening 11 at the top of the housing 1, and having two inspecting openings 31;
a light emitting device 4, connected across the two L-shape stands 25 of the terminal pin 2, for connecting the two light emitting diodes in parallel first before packaging, so that two external contact points are formed at its surface.

Referring to FIG. 2 for a perspective view of a traditional structure of a fuse terminal with light indication, the terminal pin 2 is inserted and fixed into the housing 1 through the opening 11 at the top of the housing 1, such that upper and lower ends of the terminal pin 2 are exposed from the housing 1. After the light emitting device 4 is connected across the two L-shape stands 25 of the terminal pin 2, the upper casing 3 can be covered onto the opening 11 at the top of the housing 1, and the terminal portions 24 of the terminal pin 2 can be placed into the inspecting openings 31 of the upper casing 3. Obviously, the traditional fuse terminal with light indication requires two separate complicated molds for producing the upper casing 3 and housing 1, and such arrangement will increase the manufacturing cost. Further, it is necessary to solder the light emitting device 4 onto the terminal pin 2 before fixing the light emitting device 4.

Referring to FIG. 3 for an equivalent circuit diagram of a traditional fuse terminal with light indication, the light emitting device 7 is composed of two light emitting diodes 73 that are installed in opposite directions and connected in parallel, and then a resistor 74 is connected in series. If the fuse is blown, the current will selectively flow in the same direction through the light emitting diode to emit lights. Since the two light emitting diodes 73 are installed in opposite directions and connected in parallel, the overall size of the light emitting device 7 cannot be reduced easily.

Therefore, finding a way of designing a safety power disconnection terminal apparatus with light indication to expedite the installation, improve the fuse recognition rate of a power failure and lower the manufacturing cost becomes an important subject of the present invention.

### SUMMARY OF THE INVENTION

In view of the foregoing shortcomings of the traditional fuse terminals, the inventor of the present invention based on years of experience to conduct extensive researches and experiments, and finally developed a safety power disconnection terminal apparatus with light indication to achieve the effect of expediting the installation and lower the manufacturing cost.

It is a primary objective of the present invention to provide a safety power disconnection terminal apparatus with light indication that can achieve the effect of expediting the installation and lower the manufacturing cost.

To achieve the foregoing objective, a safety power disconnection terminal apparatus with light indication of the present invention comprises: a housing, having two inspecting openings and a light transmitting portion, both disposed at the top of the housing, and an opening disposed at the bottom of the housing; a terminal pin, installed in the housing through the openings and composed of two parallel conducting plates and a fuse connected between the two conducting plates and a terminal portion disposed at an upper end of the two conducting plates and extended into the two inspecting openings, and a L-shape stand disposed proximate to an internal side of an upper end of the two conducting plates and having a free end extended upward; a light emitting device, installed in the light transmitting portion, and having two electrodes in contact with the two L-shape stands respectively to achieve the effects of expediting the installation and lowering the manufacturing cost, wherein the light emitting device forms two conducting layers of different polarities on a chip, such that the light emitting device can be coupled with another load without the need of distinguishing positive and negative contact points and always maintains a conducting layer in an electrically connected state, and ends of two voltage dividing resistors of the light emitting device are coupled respectively to the two conducting plates, and the terminal pin is installed at a load or a power source, such that if a current exceeds a rated value, the fuse will be burned to produce an open circuit and drive a current to pass through the light emitting device and drive the light emitting device to emit lights. Therefore, the present invention can achieve the effects of expediting the installation and lowering the manufacturing cost.

The above and other objects, features and advantages of the present invention will become apparent from the following detailed description taken with the accompanying drawing.

### BRIEF DESCRIPTION OF THE DRAWINGS

FIG. 1 is an exploded view of a traditional structure of a fuse terminal with light indication;

FIG. 2 is a perspective view of a traditional structure of a fuse terminal with light indication;

FIG. 3 is an equivalent circuit diagram of a traditional fuse terminal with light indication;

FIG. 4 is an exploded view of a structure of the present invention;

FIG. 5 is a perspective view of a structure of the present invention; and

FIG. 6 is an equivalent circuit diagram of the present invention.

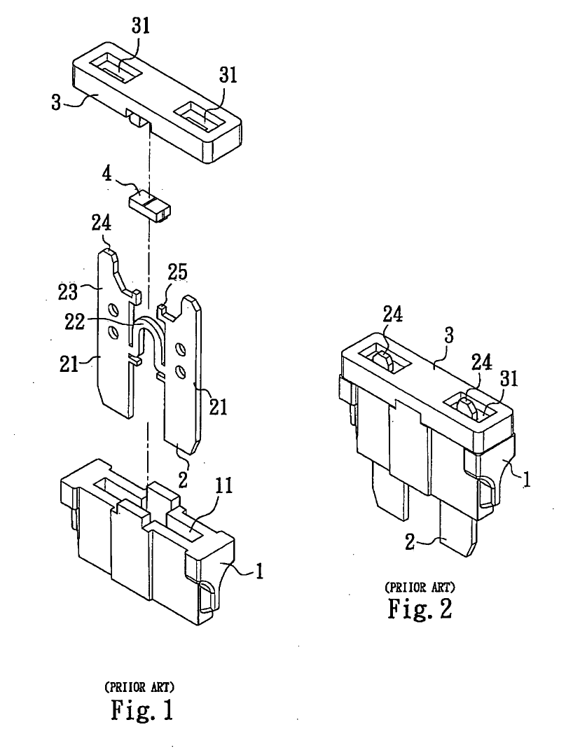

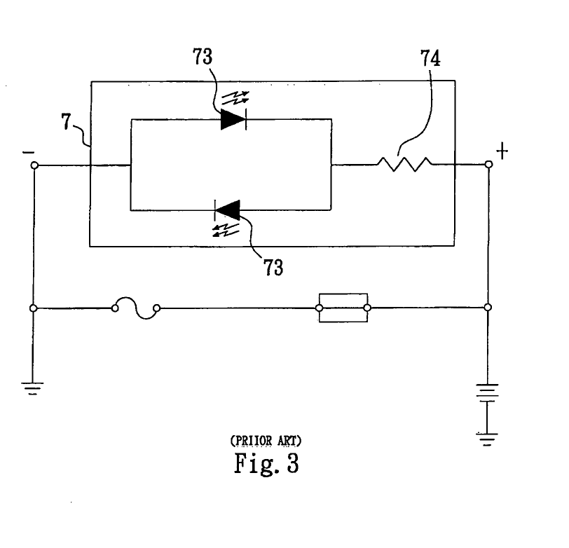

### DETAILED DESCRIPTION OF THE PREFERRED

### Embodiments

The above and other technical characteristics and advantages of the present invention will become apparent from the following detailed taken with the accompanying drawings.

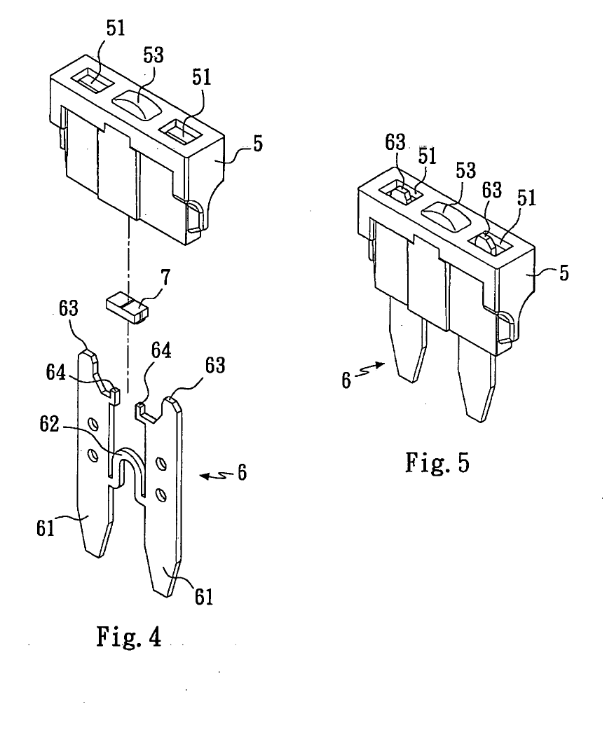

Referring to FIG. 4 for an exploded view of the present invention, the invention comprises:

an integrally formed housing 5, having two inspecting openings 51 and a light transmitting portion 53, both disposed at the top of the housing 5 and an opening disposed at the bottom of the housing 5;

a terminal pin 6, installed into the housing 5 through the openings, and comprised of two parallel conducting plates 61 and a fuse 62 connected between the two conducting plates 61, and a terminal portion 63 of the two inspecting openings 51 is extended into top ends of the two conducting plates 61 respectively, and a L-shape stand 64 disposed proximately to an internal side of the upper end of the two conducting plates 61 and having a free end extended upward;

a light emitting device 7, installed in the light transmitting portion 53, and since the light transmitting portion 53 has a shape with a cambered surface protruded outward from the top of the housing 5, the light emitted by the light emitting device 7 can pass through the cambered surface to provide a bright light, and the two electrodes of the light emitting device 53 are in contact with the two L-shape stands respectively.

Referring to FIG. 5 for a perspective view of a structure of the present invention, the light emitting device 7 is installed in the light transmitting portion 53 of the housing 5, and then the upper end of the terminal pin 6 is extended and fixed into the opening at the bottom of the housing 5 and the terminal portions 63 at the upper ends of the two conducting plates 62 are extended into the two inspecting openings 51 of the housing 5, and the light transmitting portion 53 is pressed to connect the light emitting device 7 with the L-shape stand 64.

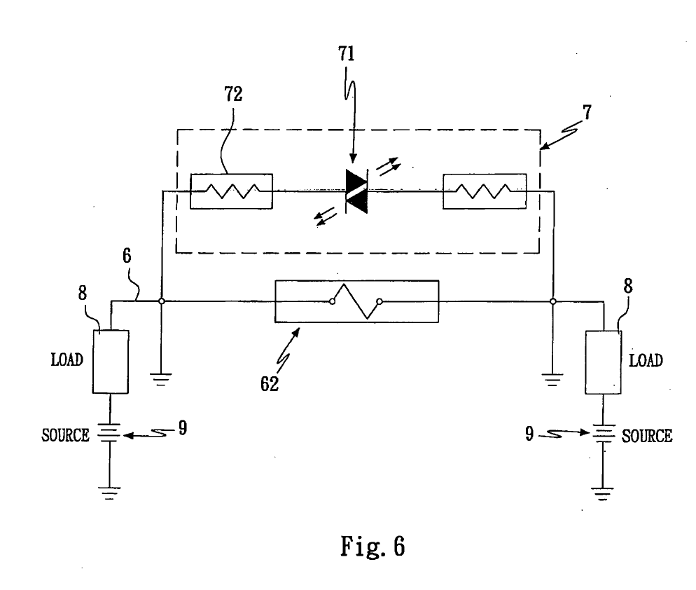

Referring to FIG. 6 for an equivalent circuit diagram of the present invention, the light emitting device 7 (including but not limited to a SMD bipolar light emitting diode 71) is composed of connecting a bipolar light emitting diode 71 and voltage dividing resistors 72 in the front and at the back of the bipolar light emitting diode 71 in series, wherein the light emitting device 7 (including but not limited to a SMD bipolar light emitting diode 71). Since the light emitting device 7 has two conducting layers with different polarities formed on the chip, therefore, the light emitting device 7 can be connected to another load without the need of distinguishing the positive and negative contact points and always maintains a conducting layer in an electrically connected state, and ends of the two voltage dividing resistors are connected to the two conducting plates 62 respectively, and the terminal pin 6 can be installed in the load 8 or the power source 9. Once if a current exceeds a rated value, the fuse 62 will be blown to produce an open circuit to force the current to pass through the light emitting device 7, so as to drive the light emitting device 7 to emit lights for informing maintenance personnel about a particular abnormal section of the circuit requires maintenance or repair.

The structural design of the present invention can save the cost of making additional molds and also can simplify the soldering process for the light emitting device 7 and the terminal pin 6, and thus the present invention definitely can achieve the effects of expediting the installation and lowering the manufacturing cost.

In summation of the description above, the invention complies with the requirements of patent application, and thus duly filed for the application.

What is claimed is:

1. A safety power disconnection terminal apparatus with light indication, comprising:
a housing, having two inspecting openings and a light transmitting portion, both disposed at the top of said housing, and an opening disposed at the bottom of said housing;
a terminal pin, installed in said housing through said openings and comprising of two parallel conducting plates, a fuse connected between said two conducting plates, a terminal portion disposed separated at an upper of said two conducting plates and extended into said two inspecting openings, and an L-shape stand disposed separately at an upper end of said two conducting plates and having a free end facing upward and extended outward from said L-shape stand; and
a light emitting device, installed in said light transmitting portion, and having two electrodes in contact with two L-shape stands respectively;
wherein said light emitting device forms two conducting layers of different polarities on a chip, such that said light emitting device can be coupled with another load without the need of distinguishing an anode and a cathode, and always maintaining a conducting layer in an electrically connected state, and ends of two voltage dividing resistors of said light emitting device are coupled respectively to said two conducting plates, and said terminal pin is installed at a load or a power source, such that if a current exceeds a rated value, said fuse will be burned to produce an open circuit and drive said current to pass through said light emitting device and drive said light emitting device to emit lights.

2. The safety power disconnection terminal apparatus with light indication of claim 1, wherein said light emitting device is a surface mount device (SMD) bipolar light emitting diode (bipolar LED).

3. The safety power disconnection terminal apparatus with light indication of claim 1, wherein said light transmitting portion has a shape with a cambered surface protruded outward from the top of said housing.
